(19) United States
(12) Patent Application Publication
(10) Pub. No.: US 2025/0378432 A1
(43) Pub. Date: Dec. 11, 2025

(54) LOCATION BASED PAYMENT SYSTEM FOR ELECTRIC VEHICLE CHARGING

(71) Applicant: HERE GLOBAL B.V., EINDHOVEN (NL)

(72) Inventor: PASI PENTIKAINEN, TAMPERE (FI)

(73) Assignee: HERE GLOBAL B.V., EINDHOVEN (NL)

(21) Appl. No.: 18/735,210

(22) Filed: Jun. 6, 2024

(51) Int. Cl. G06Q 20/32

(52) U.S. Cl. CPC G06Q 20/3224

(57) ABSTRACT

A system, method, etc. for method for providing an electric vehicle charging payment comprising obtaining an indication of at least a first location of an electric vehicle, obtaining payment data for one or more electric vehicle charge points proximate to the first location of the end user device, determining a charge point interaction indicator based, at least in part, on the obtained indication of first location and payment data for one or more electric vehicle charge points proximate to the first location, and transmitting at least one charge session payment data to the charge point.

### TECHNOLOGICAL FIELD

An example embodiment relates generally to a method, apparatus, computer readable storage medium, user interface and/or computer program product for payment at electric vehicle (EV) charging points, and more particularly, location dependent automatic payment at electric vehicle (EV) charging points.

### BACKGROUND

Electric vehicle (EV) adoption has become widespread and is predicted to continue to grow strongly in the upcoming years. EVs are generally efficient and emit fewer emissions while driving when compared to traditional vehicles with internal combustion engines (ICEs). However, the EV charging infrastructure available in most countries substantially lags compared to the petroleum fuel infrastructure and is struggling to keep pace with the EV adoption rate.

In some cases, the charging infrastructure features EV charging stations that have too few charging points for which there is too much demand. Other issues include broken chargers, high rates (cost), and confusion about how to pay as well as how long is needed to charge the EV. Moreover, there are multiple connector types and multiple charging speeds for some charging points. Yet another issue is that certain payment systems, vendors, etc. are only accepted in certain areas. Additionally, when paying for an EV charge, there is a greater potential for loss of sensitive data due to direct communication between an EV charge point and EV internal systems.

### BRIEF SUMMARY

A method, apparatus, computer readable storage medium, user interface, and computer program product are provided in accordance with an example embodiment to determine and predict the probability a given end user will interact with an electric vehicle charge point and, if there is an interaction, generate one or more forms of feedback including selection of the appropriate payment means to use.

In this regard, the method, apparatus, computer readable storage medium, and computer program product of an example embodiment may be described as obtaining an indication of at least a first location of an electric vehicle; obtaining payment data for one or more electric vehicle charge points proximate to the first location of the end user device; determining a charge point interaction indicator based, at least in part, on the obtained indication of first location and payment data for one or more electric vehicle charge points proximate to the first location; and transmitting at least one charge session payment data to the charge point. An automated vehicle control may also be generated in response to the transmitted charge payment data.

In some embodiments, the first location of an end user device may be captured by a combination of GNSS data and vehicle sensor data. The at least one charge payment data may be transmitted to the charge point is dependent upon at least end user payment preference data. The at least one charge payment data transmitted to the charge point may be dependent upon at least payment system metadata. The at least one charge payment data may be transmitted to the charge point when selected from a multitude of payment systems. The at least one charge payment data transmitted to the charge point may include at least a one-time use credit card number.

In other embodiments, the at least one charge payment data may be transmitted to the charge point includes at least a virtual credit card number. The payment data transmitted to the one or more electric vehicle charge points may be based on region specific payment data (e.g., credit cards accepted in some countries or regions and not others). The at least one charge payment data transmitted to the charge point may be estimated based on electrical vehicle battery data. The at least one charge payment data transmitted to the charge point may be transmitted from a mobile device.

All this information/feedback may be displayed on an end user device (e.g., smartphone, tablet, etc.) and/or in a motor vehicle (e.g., upon a built-in vehicle display).

In other embodiments, a UI may be provided which displays in real-time the payment credentials to be used in a list format or as another visual element of the UI. Users may also manually select the credentials, etc. from this list.

Also, a computer program product may be provided. For example, a computer program product comprising instructions which, when the program is executed by a computer, cause the computer to carry out the steps described herein.

In yet another aspect, disclosed is an apparatus and/or non-transitory computer readable medium having stored thereon instructions executable by processor(s) to cause an apparatus to perform operations described herein, such as any of those set forth in the disclosed method(s), among others.

In yet another aspect, disclosed is a computer program product including instructions which, when the program is executed by a computer, cause the computer to carry out the steps described herein, such as any of those set forth in the disclosed method(s). In other words, the computer program product may have computer-executable program code portions stored therein, the computer-executable program code portions including program code instructions configured to perform any operations set forth in any of the method(s) disclosed herein, among others.

These as well as other features and advantages of the invention will become apparent from the following detailed description considered in conjunction with the accompanying drawings where appropriate. It should be understood, however, that the drawings are designed solely for the purposes of illustration and not as a definition of the limits of the present disclosure. It should be further understood that the drawings are not drawn to scale and that they are merely intended to conceptually illustrate one or more of the features described herein. None of the examples shown or discussed herein are limiting on any aspect of the claimed subject matter.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a geographic database of an example embodiment of the apparatus;

FIG. 3A is a flowchart illustrating the operations performed, such as by the apparatus of FIG. 1, in order for an apparatus;

FIG. 3B is a flowchart illustrating the operations performed, such as by the apparatus of FIG. 1, in order to provide a graphical user interface and/or functions thereof;

FIG. 3C is a flowchart illustrating the operations performed, such as by the apparatus of FIG. 1, in order to train machine learning models;

FIG. 4A is a graphical representation of an end user exiting their home and approaching their vehicle while using the apparatus;

FIG. 4B is a graphical representation of a road upon which a passenger car is present and the apparatus is in use;

FIG. 5 is a graphical representation of a parking lot within which the apparatus is in use.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided as example embodiments to provide an automated payment service based on various data sources. In order to provide such a service, the system, method, apparatus, non-transitory computer-readable storage medium, and computer program product of an example embodiment may be configured to obtain an indication of at least a first location an end user, wherein the indication of a first location may be obtained at a predefined time interval, obtaining payment data for one or more charge points proximate to the first location of the end user, determining a charge interaction indicator based, at least in part, on the obtained indication of first location and payment data for one or more chargers proximate to the first location; and generating at least one or more forms of feedback for an end user or software client. This feedback may then be used to select appropriate payment credentials for use when paying for electric vehicle charging and/or updating one or more databases.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to detect and predict appointment attendance may similarly be embodied by the same or different server, computer workstation, distributed network of computing devices, personal computer, or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

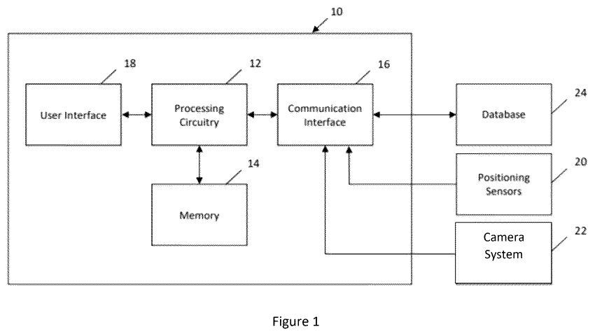

Regardless of the manner in which the system, apparatus, etc. is embodied, however, an apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally, or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally, or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively, or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., one or more map objects, POI data, etc.) generated and/or employed by the processing circuitry 12. Additionally, or alternatively, the communication interface can be configured to communicate in accordance with various wireless protocols including Global System for Mobile Communications (GSM), such as but not limited to Long Term Evolution (LTE), 3G, 4G, 5G, 6G, etc. In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally, or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links. The communication mediums may also be used to aid in position of a given end user, vehicle, and/or mobile device.

In certain embodiments, the apparatus 10 can be equipped or associated with one or more positioning sensors 20, such as one or more GPS or GNSS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus for use, such as by the processing circuitry 12, in navigation assistance and/or autonomous vehicle control, as described herein according to example embodiments.

In certain embodiments, the apparatus 10 may further be equipped with or in communication with one or more camera systems 22. In some example embodiments, the one or more camera systems 22 can be implemented in a vehicle or other remote apparatuses. The camera systems 22 may include systems which capture both image data and audio data (via a microphone, etc.).

For example, the one or more camera systems 22 can be located upon a vehicle or proximate to it (e.g., traffic cameras, security cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed upon them to enable automatic braking and other types of assisted or automated driving. Many cars also have rear facing cameras to assist with automated or manual parking. In one embodiment of the current system, apparatus, method, etc. these cameras are utilized to capture images and/or audio of end users, vehicles, streets, etc. as an end user travels/moves around. The system, apparatus, etc. takes these captured images and/or audio (via the camera systems 22) and analyzes them along with other relevant data to determine a location of an end user on a certain street, area, etc. Images of end user communications may also be captured in some embodiments. It should be noted that various types of data such as end user location data and communication data/content may be detected via any functional means.

The data captured concerning an end user's location may also come from traffic cameras, security cameras, or any other functionally useful source (e.g., historic data, satellite images, websites, NFC data, Wi-Fi positioning, etc.).

The analysis of the image data, audio data, and other relevant data concerning end user communications, location, etc. may be carried out by a machine learning model. This model may utilize any functionally useful means of analysis to identify end user location on a given roadway, road segment, building, or in a general area. The system, in this embodiment, may also examine relevant proximate points of interest (POIs), map objects, road geometries, animate objects, etc. which could suggest potential end user location information.

The locations of an end user, their vehicle, any relevant points of interest (POIs), and other types of data which are utilized by various embodiments of the apparatus may each be identified in latitude and longitude based on a location of the end user and their vehicle using a sensor, such as a GPS sensor to identify the location of the end user's device (e.g., smart phone, smart watch, tablet, etc.) and/or the end user vehicle. The POIs, map objects, infrastructure, etc. identified by the system may also be detected via the camera systems 22.

In certain embodiments, information detected by the one or more cameras or other sensors may be transmitted to the apparatus 10, such as the processing circuitry 12, as image data and/or audio data. The data transmitted by the one or more cameras, microphones, etc. can be transmitted via one or more wired communications and/or one or more wireless communications (e.g., near field communication, or the like). In some environments, the communication interface 16 can support wired communication and/or wireless communication with the one or more system sensors (e.g., cameras, etc).

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

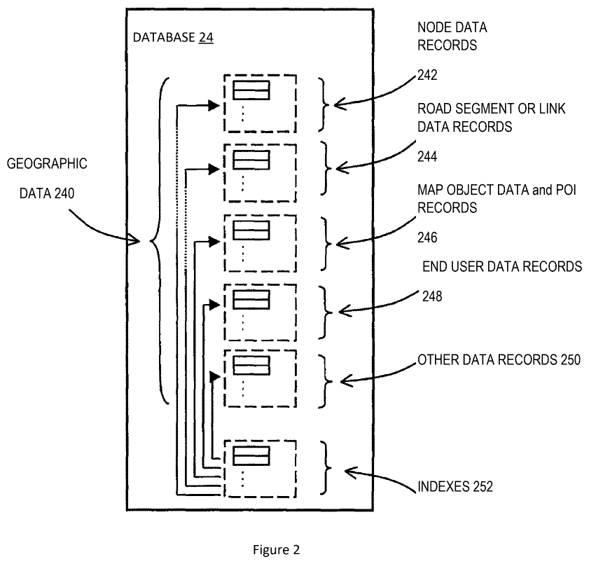

Turning to FIG. 2, the map or geographic database 24 may include various types of geographic data 240. This data may include but is not limited to node data 242, road segment or link data 244, map object and point of interest (POI) data 246, end user data records 248, or the like (e.g., other data records 250 such as payment data, payment system data, metadata about credit cards or other payment systems, regulatory compliance data, data on taxes and/or fees, etc.). The other data records 250 may include real time and historical data on acceptable payments at a given charging location. The other data records may also include metadata about the accepted payment networks/systems such as rewards, fees, etc. End user preference data may also be stored with respect to the various payment means such as use of certain credit cards at certain POIs (e.g., a dedicated company credit card for EV charging payment).

In one embodiment, the following terminology applies to the representation of geographic features in the database 24. A “Node”—is a point that terminates a link, a “road/line segment”—is a straight line connecting two points, and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The map database 24 may also include cartographic data, routing data, and/or maneuvering data as well as indexes 252. According to some example embodiments, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database 24 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example. It should be noted the map database 24 may also include data regarding the interiors of buildings, homes, offices, etc. to aid the system, apparatus, etc. in tracking end user location as the end user moves around one location or between locations.

The records for end user data 248 may include various points of data such as, but not limited to: end user location data (at a first location, second location, etc.), end user payment data, end user driving profile data (e.g., driving tendencies, etc.), data concerning a user's typical travel routine, and other end user data useful for determining if an end user will likely approach or use a proximate EV charger. The manner by which the apparatus 10 records and stores data my vary and the examples discussed herein are non-limiting.

The end user location data may, in some embodiments, include data obtained from GNSS, GPS, NFC, Wi-Fi triangulation, cellular tower information, micro-mobility data, image data of the end user, radio map data, etc. It should be noted that throughout this disclosure, end user location data may include location data of an end user and/or their end user device(s) or vehicle(s). In some situations, it may be more useful to track end user location generally or track specific location of an end user device or vehicle. For example, if an end user exits their vehicle at a charging location, it may be more useful to track the location of their EV than the location of the mobile phone. Such determination may be made in real time by the system in some embodiments.

End user payment data may include credit card information, digital wallet information (e.g. Apple Wallet, etc.), online payment system information (e.g., PayPal, Venmo, etc.), bank account information, cryptocurrency wallet information, etc. The payment data recorded and stored by the system may also include metadata about such payments including rewards programs, loyalty programs, bonuses, incentives, etc.

End user driving profile data such as end user driving patterns (e.g., cautious, slow, fast, etc.) may be obtained by any functional manner including those detailed in U.S. Pat. Nos. 9,766,625 and 9,514,651, both of which are incorporated herein by reference.

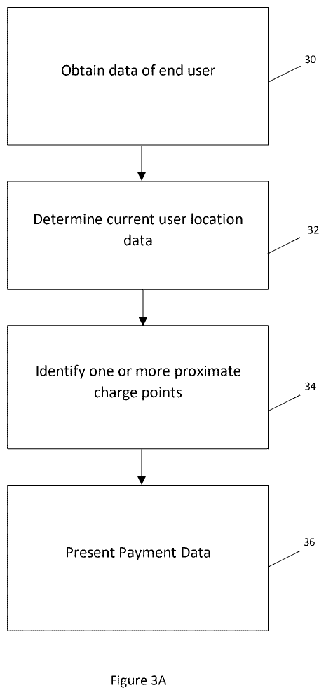

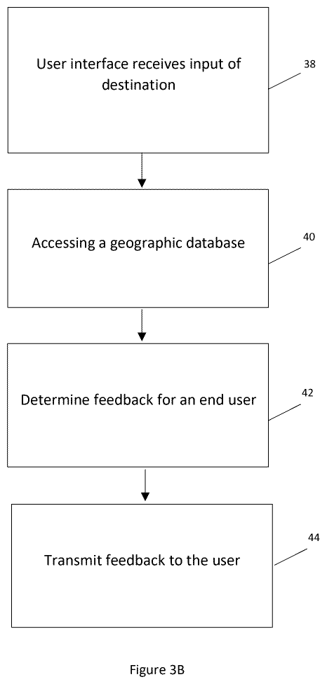

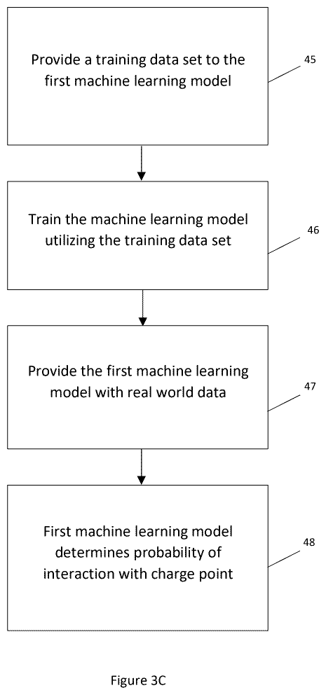

FIG. 3A is a flowchart which demonstrates how the apparatus 10 identifies an end user's location. More, fewer, or different acts or steps may be provided. At a first step (block 30) the apparatus may obtain one or more pieces of GNSS data, images, audio, or other data of at least one end user. This data may be obtained from an end user device via positioning system(s), the camera of a device, or other means commonly found in an end user device such as a smart phone. Data may also be obtained from various programs, apps, websites, etc., running on said end user device such as location guidance apps (e.g., Google Maps, Here We Go, etc.), messaging apps, social media networks, scheduling applications and/or data, etc. Data may also be captured from the camera system of a vehicle or even traffic cameras, security cameras, etc. The apparatus may be trained to analyze the data (see FIG. 3C) via machine learning model or any other functionally capable means to identify/predict the end user's location at a given time and thus their likelihood of being within or proximate to a certain charge point.

The data captured by the system may include but is not limited to location GNSS/GPS data for a vehicle, end user, etc. The presently disclosed system, apparatus, etc. may monitor, track, etc. the location of an end user at various locations throughout their day, when they travel outside a predefined area, etc.

For example, if an end user drives down a roadway on a given day in an EV the apparatus 10 may track the end user's location when their battery level drops below 20% (or some other preset level). Once the EV battery level is below this charge level, the apparatus 10 may utilize GNSS data, image data, etc. to determine the end user's location with a high degree of accuracy. This is one example of how the system might determine the location of an end user (block 32).

Once the end user's location has been identified, the apparatus may then identify one or more charge points (block 34) which the end user is traveling near or towards. The location of the charge point may be determined based on a threshold such as within a predefined distance (e.g., 100 meters) or dynamically determined based on surrounding POIs, etc. For example, if an end user is driving down a rural roadway the nearest charger might not be for several miles and thus the apparatus may adjust its criteria for proximate location in such a situation. Factors such as remaining battery charger, fuel levels (in hybrid cars), etc. may also be used by the apparatus 10 when assessing proximate charge points.

The identification of the relevant nearby charge points may be done via an end user device and/or vehicle's onboard GPS (see FIG. 1) or any other functional means. Once an end user location has been identified as within or close to a given charge point, charge station, charge kiosk, etc. the apparatus may then prepare, present, and/or transmit payment data for a EV charge (block 36) to pay for services rendered.

The control of transmission of the payment data may be tightly controlled for security purposes. For example, the transmission of the payment data may be triggered by location data (obtained via GNSS data, image data, etc.) only when a given EV is within a certain distance of a given EV charge point. This distance from the charge point may be within a predefined distance (e.g., 5 feet, etc.) and can be coupled with communication from the EV charge point to trigger payment data transmission. The communication from the charge point may include payment due, amount of charge taken in by the EV, taxes, fees, etc. The charge point data may also transmit data related to rewards, loyalty programs, advertisements, etc. Once the data regarding payment due is received by the EV and/or end user device the apparatus 10 may then generate a communication which transmits the payment data to the charge point utilized. Such payment data may also be transmitted over the internet to a payment server not located at the actual charge point.

For example, if an end user pulls up to a charging station and initiates a charge, the location of the charge may be confirmed by GNSS data, image data from vehicle cameras, and via communication with the charge point. Once charging is completed and payment due confirmed by the charge point, the apparatus 10 may access PayPal or another online payment system to transmit payment to the EV charge point operator remotely with no payment data being directly transmitted to the local charge point. This may help improve security and reduce the risk of payment data being intercepted locally.

The location where the charge and payment took place may be recorded by the apparatus. The data recorded may include but is not limited to vehicle data and metadata as well as payment data and metadata. This data in all its forms may be used to generate alerts and analyze other similarly situated chargers to enable the apparatus 10 to predict potential charging payment needs. The apparatus 10 may in some embodiments automatically (or manually with prompting) select a commonly used payment method at a given charger due to better rewards, less fees, faster payment speed, most secure payment option, etc.

Turning to FIG. 3B, the apparatus 10 may support a user interface 18 (shown in FIG. 1). More, fewer, or different acts or steps may be provided. At a first step, the user interface may receive an input of destination from an end user (block 38). This input of destination may be received via an end user device graphical user interface (GUI) running upon a smartphone, tablet, integrated vehicle navigation system, etc. Once a destination is input, the apparatus may then access a geographic database (block 40) and determine a route to the input destination (block 42). The determined route may, in some embodiments, avoid (or select) at least one road segment in response to an electric vehicle charging location. As mentioned above, the determination of the EV charger(s) to suggest to an end user may be based on any functionally capable means including proximity and other data or metadata about charge points, end user preferences, payment methods, etc.

Notwithstanding how the apparatus generates a determination of the EV charger to suggest to an end user, this information may then be used to route an end user towards or away from certain road segments when generating a route. The route determined by the apparatus 10 may then be displayed to the end user (block 44) via the same or a different user interface. The apparatus can take any number of additional actions (or in place of) what is called for in block 44. For example, the apparatus may provide audio guidance instead of a visual display. The navigation instructions may also be provided to an autonomous vehicle for routing (for example, without any display to the user). It should also be noted the UI can be run by a processor and stored upon one or more types of memory in some embodiments.

An example of the above embodiment would be that of an end user approaching a charger. Not all chargers are well marked nor is it typically outlined what payments may be utilized at a given charge point. Based on data in one or more geographic databases, etc. the apparatus 10 may predict or determine that a given vehicle may be routed to one EV charger over another if both chargers are proximate to the vehicle. This decision may be carried out by a machine learning model (see below) in some embodiments based on information about the electric vehicle (e.g., compatibility with a given charge point), payment methods accepted, charge point availability, etc.

Referring now to FIG. 3C, the operations performed, such as by the apparatus 10 of FIG. 1, in order to train a machine learning model to detect and/or predict the likelihood of interaction between an EV and a charge point based on one or more indicators. More, fewer, or different acts or steps may be provided. As shown in block 45, the apparatus 10 includes means, such as the processing circuitry 12, memory 14, the communication interface 16 or the like, for providing a training data set that includes a plurality of training examples. In this regard, the training data set may be provided by access by the processing circuitry of the training data set stored by the memory. Alternatively, the training data set may be provided by access by the processing circuitry to a database 24 or other memory device that either may be a component of the apparatus or may be separate from, but accessible to the apparatus, such as the processing circuitry, via the communication interface. It should be noted the system apparatus may utilize more than one machine learning model to carry out the steps described herein.

In accordance with an example embodiment, the apparatus 10 also includes means, such as the processing circuitry 12, the memory 14 or the like, configured to train a machine learning model utilizing the training data set (block 46). The machine learning model, as trained, is configured to detect and predict electric vehicle charge point interaction indicators. The prediction may be based, at least in part, upon end user location data (obtained from GNSS, etc.).

The apparatus 10, such as the processing circuitry 12, may train any of a variety of machine learning models to identify indicators based upon a single or plurality of data points, images, audio, etc. Examples of machine learning models that may be trained include a decision tree model, a random forest model, a neural network, a model that employs logistic regression or the like. In some example embodiments, the apparatus, such as the processing circuitry, is configured to separately train a plurality of different types of machine learning models utilizing the same training data including the same plurality of training examples. After having been trained, the apparatus, such as the processing circuitry, is configured to determine which of the plurality of machine learning models predicts interaction indicators with the greatest accuracy. The machine learning model that has been identified as most accurate is thereafter utilized.

In one example, the machine learning model may be a deep learning neural network computer vision model that utilizes user location data, communication data, scheduling data, etc. to automatically identify interaction indicators. A training example for this first machine learning model may include data demonstrating known travel patterns, routines, etc. for end users. For example, if an end user has a typical travel routine for work (Monday-Friday) such as driving to an office building (or other POI(s)) each day and then driving home later in the day the machine learning model can be provided this set of location data to act as baseline for the location of an end user. As the end user drives along their typical route, they may pass one or more electric vehicle chargers and the apparatus 10 may note that there is higher probability of interaction with these charge points for the given end user.

Additionally, if an end user then has to travel outside of their routine, the model will be able to detect the departure from the normal travel routine based on the new location data of the end user and update a suggested list of charge points, etc. as needed in real-time or near real-time.

Various types of metadata about the charge points may also be provided to the machine learning model to train and improve its accuracy. For example, if a charge station is cheaper at one point of the day versus others, this may be used by the apparatus to prioritize the cheaper charging point at one point during the day, then move it down the suggested list for a given end user at other points during the day.

In some example embodiments, a balance or trade-off between the accuracy with which the indicators are identified and the efficiency with which the machine learning model identifies them is considered. For example, a first set of data, images, audio, etc. may produce the most accurate identification, but a second combination of data, images, audio, etc. may produce an identification of indicators (e.g., GNSS data, image data, scheduling data) that is only slightly less accurate, but that is significantly more efficient in terms of its prediction. Thus, the second combination of data that provides for sufficient, even though not the greatest, accuracy, but does so in a very efficient manner may be identified by the apparatus 10, such as the processing circuitry 12, as the data for end users to be provided to the machine learning model to identify EV charge interaction indicators in subsequent instances.

In some embodiments, a training example also includes information regarding a map object, such as a map object that is located at the location at which the data concerning end user communication was captured. One example of a map object is a bridge, and another example of a map object is a railroad crossing or median. A wide variety of other map objects may exist including, for example, walls/fences, manhole covers, transitions between different types of road surfaces, medians, parking meters, various forms of infrastructure, or the like. As described in more detail below, the map object that is included in a training example may be determined or provided in various manners. For example, the map object may be defined, either manually or automatically, by reference to a map database 24 and identification of a map object at the same location or at a location proximate, such as within a predefined distance of, the location at which the corresponding image data was captured. The training example may also include point of interest (POI) data. A POI may be something like a single EV charge point, a larger charging station, hospital, restaurant, park, school, bus stop, etc. Relevant POIs may also be defined, either manually or automatically, by reference to a map database 24 and identification of a POI at the same location or at a location proximate, such as within a predefined distance of, the location at which the corresponding image data was captured. The location of relevant POIs and/or map objects may be found by GPS coordinates or any other functionally capable means.

Yet other various types of data may also be utilized when training the machine learning model including map geometry data, historic data, indoor mapping data, geolocation data, Wi-Fi mapping (e.g., triangulation) data, hotspot data, etc. Ground truth data may also be utilized with a combination of these different features for supervised machine learning.

It should also be noted in some examples the apparatus, system, etc. may monitor charge point availability in addition to location. In some cases, EV chargers are occupied for longer stretches making them less useful to suggest to a proximate end user who needs immediate charging. Such data may be obtained and monitored by apparatus 10 in real-time from charge point operators, camera systems, etc.

Once trained, the machine learning model may then be provided various real-world data as mentioned in block 47 and used to determine EV charge point interaction indicators.

An example of the apparatus 10 detecting and/or predicting an EV charge point interaction may be based on various factors. For example, a mobile phone may be paired with an electric vehicle and the apparatus may monitor the location of the phone (and vehicle). As the end user travels around, the EV battery range may be determined by the apparatus 10 based on real-time data transmitted from the EV or estimated based on the range the given EV typically drives. In this example, the end user may set up an automatic alert for when their EV battery is below 30% charge. Once this charge level is depleted to this low level, the apparatus 10 may use this as a first indication that charging will happen some time soon. Based on this deduction, the apparatus 10 may examine the current GNSS location data for the end user's mobile device (or via their EV's internal systems) and suggest one or more EV chargers in the area. The suggested chargers may be presented as a UI list, audio suggestion, or any other useful means.

The apparatus 10 may also continue to monitor GNSS location information to determine the location of the EV relative to known chargers in the area. When an EV is within a certain proximity to a charging station, payment information may be prepared and/or transmitted by the apparatus 10 once charging fee(s) have been incurred. Transmission may be done by local wired or wireless transmission (EMV credit card chip data for example) or payment may be transmitted over the internet to any functional payment service or means.

The machine learning model in this example makes its determination based on a combination of specific factors (map data, communication data, image data, location data, scheduling data, etc.), and the model predicts the potential of charging because of specific factors in a specific combination or configuration are present. The factors in this example may include data extracted from the end user's physical location at various times (e.g., at least a first time), image data of roadways, as well as time of day data, historic data, etc. This set of data, provided to the model, matches (or is like) the factors used in the training process (in this example). This allows the machine learning model to predict if an end user is likely to charge their car at a given location and if they were to charge their car, what payment they would/should subsequently use to pay for the charging session.

The apparatus 10 may also use various events to trigger obtention of end user or device location. These might include but are not limited to a series of predefined time intervals, on end user demand, on application invocation/start up, or upon powering on of an end user device. Obtention of the first location of an end user device may also be triggered by change of cell tower or change of mobile network the end user device is connected to or a change in the Wi-Fi access points detected by the end user device.

The determination of one or more charge point interaction indicators can then be utilized in various ways. For example, the apparatus 10 may alert end users via graphical user interface that they could be using an expired credit card and need to update their payment settings. The apparatus 10 might also automatically update one or more software or device settings to connect to the appropriate website URL for payment, utilize with correct payment encryption, etc. The apparatus 10 may also update one or more map layers and/or databases to account for this determination and use these entries to update settings for a given end user or other end users automatically in the future. It should be noted end users of the apparatus 10 might be human end users, automated devices, software clients, etc. In some embodiments, the data from the apparatus 10 may also be integrated into one or more additional software solutions/services.

As mentioned before, the apparatus 10 features one or more machine learning models. This model and other data may be used by the apparatus 10 to not only analyze real time driving situations as mentioned above but also examine existing map data to identify other similarly situated roadways. These similar roadways will have similar POIs, map objects, etc. So, for example, if there was a roadway near an EV charger which users typically navigate to, the apparatus 10 may be able to detect these similar roadways with proximate EV chargers in other areas and provide alerts, settings updates, route guidance, etc. to another end user.

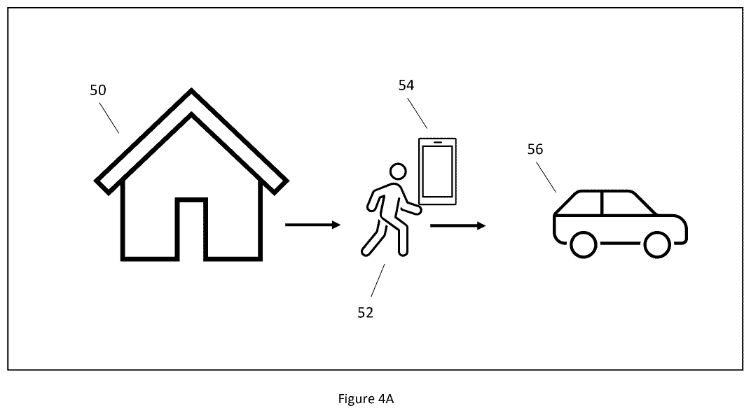

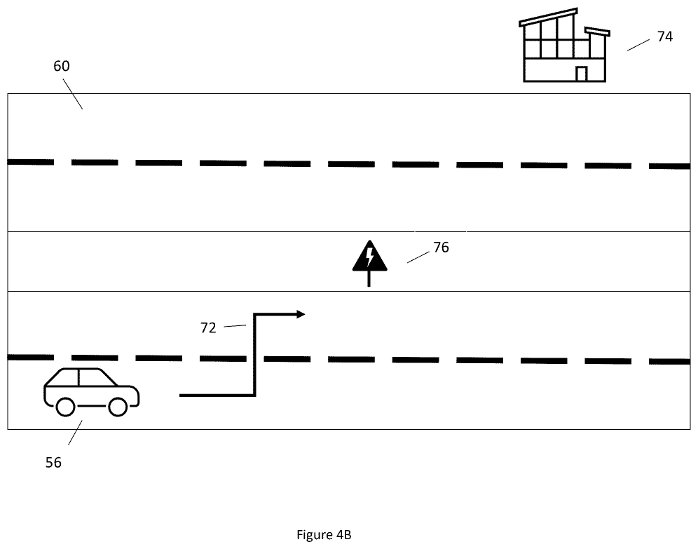

Turning to FIG. 4A, some of the examples discussed above are illustrated. Specifically, an end user 52 is shown exiting their home 50 and approaching their sedan 56. As shown in FIG. 4A, the end user 52 is utilizing apparatus 10 upon their end user device 54 to detect and/or predict EV charge point utilization and payment. The apparatus 10 identifies the user's location (moving from house to car) via GNSS data and/or images from a camera system 22 (or other security cameras, traffic cameras, etc.) and feeds those images into the machine learning model along with other data such as information concerning if the end user has booked a time at a charging location (obtained from EV charge point operator data, end user scheduling data, SMS data, etc.). The apparatus then takes this data along with relevant other information such as POI or image data of roads in the area, etc. and feeds all the data to the machine learning model (or to another model, algorithm, etc.) to determine if the given end user will likely be utilizing a charge point.

It should be noted that the sedan 56 in this example may represent any vehicle. Such vehicles may be standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle, assisted driving vehicle, or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the vehicle, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this example, the end user 52 does not have an EV charger at their home thus the payment information may be securely stored offline for the time being and only presented when location data confirms they are proximate to an EV charger.

In some embodiments, the apparatus 10 may extract information by use of OCR and/or NLP. In one embodiment, the apparatus 10 may use optical character recognition (“OCR”) in conjunction with one or more databases (see FIG. 2) to determine text or characters of a sign or marking for EV chargers. Additionally, the apparatus 10 may compare features or components (such as invariant components relating to an emoji) in or from images to reference features or components in one or more reference databases (or data libraries) to detect a symbol or feature (such as angry emojis, exclamation points, etc.). The apparatus 10 may then record (in a database) the determined text, the identified symbols and/or graphics thereof, and/or other features or determinations. For example, the end user 52 may be driving past a road sign that says, “EV CHARGING TEN MILES”. The apparatus 10 can extract this text along with any exclamation points, symbols, emojis, etc. and use this information to determine the message's meaning and content, at least in part, by comparing the message's content to a current database of reference information.

As mentioned above, OCR may be used to extract the information from an end user message and natural language processing (NLP) technologies may be used in conjunction with the OCR tools to aid the apparatus 10 in analyzing the messages. NLP may be used in some embodiments to address issues around word segmentation, word removal, and summarization to determine the relevancy of the various parsed data. In various embodiments, semantics of the various parsed data are determined based on a vocabulary model in a grammar module. For example, in various embodiments, probabilistic latent semantic indexing (pLSI) or Latent Dirichlet allocation (LDA) may be used to deduce semantics from words in the extracted message information and determine the information's relevancy. Such methods can be used to derive text and topics from a set of predefined terms.

Based off this information, the apparatus may provide to the end user 52 feedback, alerts, suggestions, etc. In some embodiments, this feedback might be computerized instructions which cause one or more software programs and/or devices to change one or more settings to enable payment at an EV charge point. This could be credit card data settings, privacy settings, encryption settings, data formatting, switching from connecting to one online payment method to another, etc. The feedback might also be an alert (e.g., the EV charger you are approaching only accepts credit cards). The information may also be used to provide route guidance to avoid certain charge points. Alerts, settings updates, and routing information may also be provided to other user(s) in the area.

The feedback generated may also be used to select both a preferred payment system and payment method. For example, in some cases credit cards allow for the generation of single use credit card numbers if the end user is concerned about security. The feedback may be used to pay through Apple Pay or PayPal and also utilize a single use credit card number or virtual credit card number if the given EV charge point has never been utilized before.

Route guidance, when generated, may include various guidance options, visual and/or audio. For example, visual guidance on how and when to change lanes or audio guidance relaying the same information. Automatic driver controls like those for an autonomous vehicle (e.g., an automatic lane change that can include an explanation to the passenger on what is happening), etc. The guidance itself can include the alert messages as mentioned above so the generation of alerts and route guidance can be the same function. When calculating the route and route guidance, metadata such as a data flag or attribute of road segments may be taken into consideration when forming different suggested routes and one or more segments may be excluded from these routes when it is determined (by the apparatus) that one or more interaction area indicators are associated with the omitted segment(s).

In some embodiments, apparatus 10 may generate a confidence interval/score which reflects the likelihood an end user will interact with or enter a given charge point. Building on one of the examples above, the apparatus 10 can detect an end user location, EV charge level, and the road sign indicating an EV charger is nearby. From this, the apparatus 10 may generate a score of 0.75 out of 1 (on a scale of 0-1). The apparatus 10 may then receive additional information from other sources (e.g., ongoing updates to end user location data, metadata traffic camera data, traffic alerts, real-time driving behavior of the end user, etc.) which can increase or decrease this confidence score. For example, if the EV charge level drops to 5% and there are no other EV charge points proximate to the EV, the confidence score may be boosted. Alternatively, if the EV charge point is not compatible with the given EV, the confidence score may be reduced.

It should be noted that the confidence interval/score described above may itself act as a interaction indicator and/or may also be used as part of a greater analysis and combined with other factors when determining likelihood of interaction with an EV charger.

FIG. 4B illustrates another example embodiment. Specifically, the sedan 56 from FIG. 4A is shown driving down a roadway 60. As shown in FIG. 4B, the sedan 56 is utilizing the apparatus 10 to adjust and manage payment at an EV charge point. The apparatus 10 identifies the sedan 56 based on the information discussed above and feeds the GNSS data, images, etc. into a machine learning model which determines the likelihood the end user driving the sedan 56 will utilize EV chargers in the area. In this example, the end user is headed to a shopping mall 74 along the roadway. The end user is navigating to the building by use of a GPS navigation system which is proving routing information 72.

As the end user travels down the roadway, they pass a road sign 76 which indicates the mall 74 has EV charging available. This determination may be made by the apparatus 10 by use of image data of the sign 76 analyzed by OCR, NPL, and/or machine learning (discussed above) to extract the sign 76 information.

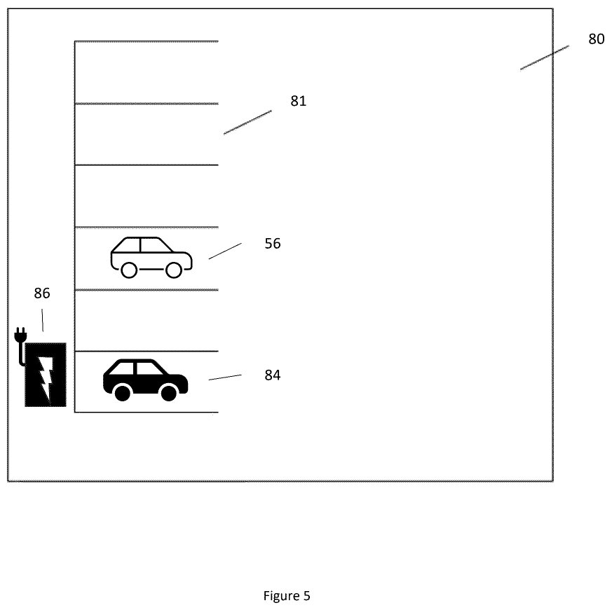

In this example, since the routing information is guiding the end user towards the mall 74 and the mall is confirmed to have EV charging, the apparatus 10 may detect when the end user gets close to the charge point as confirmed by GNSS data, car camera systems, security cameras, etc. The apparatus may then produce one or more types of feedback (discussed above) to prepare for/enable payment (see FIG. 5). In this example and others, the navigation application/functions discussed may transmit feedback to another application such as a standalone payment application. This feedback may cause the other application(s) to launch and/or enable payment at a given charge point without the need for payment data being handled by the navigation application.

It should be noted that the application(s) activated by the apparatus 10 feedback (based on location data, etc.) may include applications for EV control supported by vehicle OEMs. The applications may also include those which grant access to national or regional charging station networks such as the networks operated by: 7Charge, Blink, ChargePoint, Electrify America, Electrify Canada, EVgo, FLO Network, Shell Recharge, the Tesla Supercharger Network, Volta Charging, West Coast Electric Highway, and/or PlugNYC. As mentioned above, most EVs have an accompanying smartphone application which can enable vehicle functions such as remote start, remote unlock, etc. The apparatus 10 is envisioned to, in some embodiments, send data/feedback to and from these EV smartphone applications in real-time for navigation, payment transmission, etc.

FIG. 5 illustrates another example embodiment. As shown, a mall parking lot 80 contains parking spaces 81 some of which are normal parking spaces and others are designated for EV parking and located by an EV charge point 86. In this example, the end user of sedan 56 has navigated to the mall parking lot 80 with an EV battery level of 10%. The apparatus 10 may determine that there is a high likelihood the sedan 56 will be charged at the charge point 86 based on this information. The apparatus 10 may automatically confirm the charge point is active, compatible, available, etc. The apparatus 10 may also confirm the payment methods an end user has (e.g., credit cards, rewards points, etc.) are accepted by the charge point 86. In this example, another car 84 is currently utilizing the charge point 86 but, this charge point has two available charging cables so the end user of sedan 56 may also access the charge point 86. In this example, the end user of the sedan 56 is altered to the situation by the apparatus 10 and shown which parking spaces 81 they may park at in the lot 80 to access the charge point 86. Such data, in this example, is obtained in real-time from the charge point 86 operator via the internet.

In this example, the sedan 56 has a low battery charge level and it will take an hour for their EV battery to charge to 100%. Thus, in this embodiment, the end user elects to leave their vehicle charging and have an alert sent to their mobile phone when charging is completed. Once charging is completed, the end user may then opt, via the apparatus 10 to automatically transmit payment data locally from their EV's onboard computer systems to the EV charge point 86. Payment could also be made over the internet to the charge point operator with no or minimal payment data transmitted locally. It should be noted that payment may also be made as a condition to enable charging (e.g., upfront payment) or payment may be made during the charging session (e.g., pay while you charge).

It will be understood that each node block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for providing an electric vehicle charging payment comprising:
obtaining an indication of at least a first location of an electric vehicle from a combination of GNSS data and vehicle sensor data;
obtaining payment data for one or more electric vehicle charge points proximate to the first location of an end user device;
determining a charge point interaction indicator based, at least in part, on the obtained indication of first location and payment data for one or more electric vehicle charge points proximate to the first location;
transmitting at least one charge session payment data to a charge point, wherein the at least one charge session payment data transmitted to the charge point is estimated based on electrical vehicle battery data; and
generating an automated vehicle control in response to the transmitted charge payment data, wherein the automated vehicle control navigates to the charge point.

2. (canceled)

3. The method according to claim 1, wherein the at least one charge payment data transmitted to the charge point is dependent upon at least end user payment preference data.

4. The method according to claim 1, wherein the at least one charge payment data transmitted to the charge point is dependent upon at least payment system metadata.

5. The method according to claim 1, wherein the at least one charge payment data transmitted to the charge point is selected from a multitude of payment systems.

6. The method according to claim 1, wherein the at least one charge payment data transmitted to the charge point includes at least a one-time use credit card number.

7. The method according to claim 1, wherein the at least one charge payment data transmitted to the charge point includes at least a virtual credit card number.

8. The method according to claim 1, wherein the payment data transmitted to the one or more electric vehicle charge points is based on region specific payment data.

9. (canceled)

10. (canceled)

11. The method according to claim 1, wherein the at least one charge payment data transmitted to the charge point is transmitted from a mobile device.

12. An apparatus, the apparatus comprising at least one processor and at least one memory storing computer program code, the at least one memory and the computer program code configured to, with the processor, cause the apparatus to at least:
obtain an indication of at least a first location of an electric vehicle from a combination of GNSS data and vehicle sensor data;
obtain payment data for one or more electric vehicle charge points proximate to the first location of an end user device;
determine a charge point interaction indicator based, at least in part, on the obtained indication of first location and payment data for one or more electric vehicle charge points proximate to the first location;
transmit at least one charge session payment data to a charge point, wherein the at least one charge session payment data transmitted to the charge point is estimated based on electrical vehicle battery data; and
generating an automated vehicle control in response to the transmitted charge payment data, wherein the automated vehicle control navigates to the charge point.

13. (canceled)

14. The apparatus according to claim 12, wherein the at least one charge payment data transmitted to the charge point is dependent upon at least end user payment preference data.

15. (canceled)

16. The apparatus according to claim 12, wherein the at least one charge payment data transmitted to the charge point is selected from a multitude of payment systems.

17. The apparatus according to claim 12, wherein the at least one charge payment data transmitted to the charge point includes at least a one-time use credit card number.

18. The apparatus according to claim 12, wherein the at least one charge payment data transmitted to the charge point includes at least a virtual credit card number.

19. The apparatus according to claim 12, wherein the payment data transmitted to the one or more electric vehicle charge points is based on region specific payment data.

20. The apparatus according to claim 12, wherein the at least one charge payment data transmitted to the charge point is transmitted from a mobile device.
